(19) United States
(12) Patent Application Publication
(10) Pub. No.: US 2006/0135026 A1
(43) Pub. Date: Jun. 22, 2006

(54) Composite cleaning products having shape resilient layer

(75) Inventors: Jonathan K. Arendt, Appleton, WI (US); Walter G. Bauer, Neenah, WI (US); Frank Gerald Druecke, Oshkosh, WI (US); Frederick J. Lang, Neenah, WI (US); Leslie B arnett Taneri, Appleton, WI (US); Eugenio Go Varona, Marietta, GA (US); Fung-Jou Chen, Appleton, WI (US); Jeffrey Dean Lindsay, Appleton, WI (US); Julie Marie Bednarz, Neenah, WI (US); Catherine A. Nennig, Neenah, WI (US); Richard B. Timmers, Appleton, WI (US); Andrew Kuo, Appleton, WI (US)

Correspondence Address: DORITY & MANNING, P.A., POST OFFICE BOX 1449, GREENVILLE, SC, 29602-1449, US

(73) Assignee: Kimberly-Clark Worldwide, Inc.

(21) Appl. No.: 11/022,323

(22) Filed: Dec. 22, 2004

(51) Int. Cl. B32B 5/26; D04H 1/56

(52) U.S. Cl. 442/400; 442/408; 442/387; 442/389; 442/414; 442/416

(57) ABSTRACT

The present invention discloses a disposable cleaning product for use in household cleaning or personal care applications. The cleaning product of the invention is a multi-layer laminate product and may include at least two distinct layers, an abrasive layer and an absorbent layer. The absorbent layer contains a sponge-like member optionally in combination with a plurality of cellulosic fibrous webs. The sponge-like member can be made from various materials. For example, in one embodiment, the sponge-like member comprises one or more layers of a spunbond web containing crimped, bicomponent filaments.

### BACKGROUND OF THE INVENTION

Abrasive scrubbing pads are commonly used for many cleaning and personal care practices. In general, scrubbing pads include a naturally occurring or manufactured abrasive material. Examples of typical abrasive materials commonly used in the past include pumice, loofah, steel wool, and a wide variety of plastic materials. A non-absorbent abrasive material is often combined with an absorbent sponge-like backing material in these products. For example, the abrasive material often forms a layer on a multi-layer product which also includes an absorbent layer of natural sponge, regenerated cellulose, or some other type of absorbent foamed product.

These scrubbing pads tend to be expensive, making them unsuitable for a disposable or single-use product. Due to the nature of the product use, however, the products can become fouled with dirt, grease, bacteria, and other contaminants after only one or two uses. As a result, consumers must replace these expensive scrubbing pads quite often in order to feel secure in the knowledge that they are using an uncontaminated cleaning pad.

Examples of abrasive cleaning articles have been described in the past. See, for example, International Published Application Number WO 02/41748, U.S. Pat. No. 5,213,588, and U.S. Pat. No. 6,013,349.

The present invention addresses these and other problems encountered with scrubbing pads in the past and is directed to scrubbing pads that are meant to be disposable after a few uses or after a single use. The scrubbing pads are comfortable and easy to hold, may have good absorbency, and may provide benefits not previously supplied in abrasive cleaning articles in the past. In particular, the disposable scrubbing products have good “spring-back” properties in that the scrubbing products bounce back to their original shape after being squeezed while wet. The scrubbing products are inexpensive to make and, in some embodiments, offer a combination of properties that provide various other improvements over prior art constructions.

### SUMMARY OF THE INVENTION

The present invention is directed to a disposable cleaning product for use in household cleaning or personal care applications, as well as industrial cleaning and other applications. The cleaning product may be a scrubbing product and/or a wiping product.

In general, the product as described in more detail below includes a liquid absorbent structure and an additional exterior layer such as an abrasive layer forming an exterior surface of the product. In one embodiment, the liquid absorbent structure comprises a sponge-like member containing meltspun filaments. The sponge-like member may have a density of less than about 0.08 g/cc, such as less than about 0.05 g/cc, less than about 0.04 g/cc, or even less than 0.03 g/cc. The sponge-like member comprises at least 20% by weight of the liquid absorbent structure. For instance, the sponge-like member may comprise from about 25% to 100% by weight of the liquid absorbent structure, or from about 50% to 100% or from about 40% to 80% by weight of the liquid absorbent structure. In one embodiment, substantially all of the liquid absorbent material consists essentially of the sponge-like material. In other embodiments, less than 90% or less than 70% of the dry mass of the liquid absorbent structure comprises a sponge-like member.

The sponge-like member may comprise a single layer of material or multiple layers of material. When multiple layers are present, they may be adjacent or separated by the placement of one or more other components such as tissue layers therebetween. The sponge-like member may have a basis weight, for instance, of at least 50 gsm, such as at least 100 gsm. For example, in particular embodiments, the sponge-like member may have a basis weight of at least 150 gsm, such as at least 200 gsm.

The sponge-like member may comprise at least about 10% by weight of the dry weight of the disposable cleaning product, such as any of the following ranges for the percentage of the dry weight of the disposable cleaning product taken up by the mass of the sponge-like member: about 20% or greater, about 40% or greater, about 50% or greater, about 60% or greater, from about 20% to about 90%, from about 20% to about 60%; from about 50% to about 90%; and from about 10% to about 45%.

In one embodiment, the sponge-like member is comprised of spunbond multi-component filaments. The multi-component filaments may be, for instance, bicomponent filaments in a side-by-side relationship. The bicomponent filaments, for instance, may comprise a first polyolefin component and a second polyolefin component, such as a first polyethylene component and a second polypropylene component. When formed into a meltspun web and heated, the bicomponent filaments are crimped which imparts various desired properties to the nonwoven web.

The multi-component filaments may comprise at least 20% by weight of the liquid absorbent structure. For instance, the sponge-like member may comprise from about 25% to 100% by weight of the liquid absorbent structure, or from about 50% to 100% or from about 20% to 90% by weight of the liquid absorbent structure. In one embodiment, substantially all of the structural material of the liquid absorbent structure consists of multi-component filaments.

The multi-component filaments may comprise at least about 10% by weight of the dry weight of the disposable cleaning product, such as any of the following ranges for the percentage of the dry weight of the disposable cleaning product taken up by the mass of the multi-component filaments: about 20% or greater, about 40% or greater, about 50% or greater, about 60% or greater, from about 20% to about 90%, from about 25% to about 80%, from about 20% to about 60%; from about 50% to about 90%; and from about 10% to about 45%.

The liquid absorbent structure contained in the cleaning product may be made from the sponge-like member only or may be made from multiple components. For example, in one embodiment, the sponge-like member may be combined with a plurality of fibrous cellulosic webs, such as paper webs. The paper webs may be, for instance, uncreped, through-air dried webs. The absorbent structure can contain from about two plies to about 100 plies of the cellulosic webs. For example, the absorbent structure can contain at least eight plies, such as at least 12 plies. The plies can be separate or connected together at their edges, such as in a folded relationship.

In addition to uncreped, through-air dried webs, it should be understood that the fibrous cellulosic webs may also comprise various other structures. For instance, the fibrous cellulosic webs may comprise other wetlaid webs, airlaid webs, coform webs, hydroentangled webs, bonded carded webs, or mixtures thereof. The mass of fibrous cellulosic material, or specifically of tissue and/or paper webs, may represent about 10% or more of the dry mass of the cleaning product, and may represent about 20% or more, about 40% or more, about 50% or more, about 60% or more, or about 70% or more of the dry mass of the cleaning product or of the mass of the liquid absorbent layer.

Other than papermaking fibers, other cellulosic materials and derivatives may be present, such as rayon or regenerated cellulose. However, in one embodiment, the cleaning product is substantially free of regenerated cellulose, or does not comprise a non-fibrous cellulosic sponge. In other embodiments, less than 10% of the mass of the cleaning product is regenerated cellulose. In another embodiment, less than 20% or less than 10% by weight of the dry cleaning product is a foam. In one embodiment, the entire cleaning product or the liquid absorbent layer or any component excluding the exterior surfaces of the article is substantially free of at least one of the following: a foam, a synthetic foam, a thermoplastic foam (note that melamine foam is not a thermoplastic foam), a polyurethane foam, a cellulose sponge, a natural sponge, and a regenerated cellulose foam.

In addition to tissue layers or nonwoven layers, other absorbent materials may be present. For example, superabsorbent particles, fibers, or webs may be included in the article (e.g., particles or fibers may be in a laminate with tissue or nonwoven webs, adhesively attached to the filaments of a sponge-like member, contained within a fluid pervious pouch, and so forth). If desired, superabsorbent absorbent material may comprise, for example, from about 1% to about 10% of the dry mass of the cleaning product. Layers of woven or nonwoven absorbent fibers such as cotton, hemp, and papermaking fibers may be present in a variety of forms (e.g., a layer of unbonded comminuted fibers in a protective fluid-pervious wrap).

In one embodiment, the fibrous materials of the liquid absorbent layer, whether synthetic polymeric materials such as meltspun fibers or from papermaking fibers in tissue, coform, or other webs, when combined comprise a percentage of the dry mass of the liquid absorbent layer or a percentage of the mass of the dry mass of the entire cleaning product that can be any of the following: about 30% or greater, about 40% or greater, about 50% or greater, about 60% or greater, about 70% or greater, about 80% or greater, and about 90% or greater, such as from about 30% to about 90%, or from about 40% to about 90%, or from about 40% to about 80%. In one embodiment, the fibrous materials of the cleaning product comprise about 70% or greater of the mass of the cleaning product, or about 80% or greater of the mass of the cleaning product.

In one embodiment, the liquid absorbent structure may be contained within a cover layer. For example, the cover layer may comprise a hydroentangled web that comprises a spunbond web that has been hydroentangled with cellulose fibers. Hydroentangled webs are not only soft and capable of absorbing liquids, but are also heat fusible. Thus, when present, the hydroentangled cover layer may be heat fused around the perimeter of the cleaning product to form a seam.

As described above, the cleaning product may further include an abrasive layer, which forms an exterior surface of the product. When a cover layer is present, for instance, the abrasive layer may be attached to the cover layer. In one embodiment, the abrasive layer comprises a meltspun web that is deposited and attached to the cover layer or, when a cover layer is not present, is deposited or attached directly to the liquid absorbent structure. The abrasive meltspun web may be, for instance, a meltblown web. The meltblown web may contain polymeric fibers having a diameter of at least 40 microns, and in one embodiment, about 10% or more, about 20% or more, or about 40% or more, of the mass of the meltblown web comprises fibers having a diameter of at least 40 microns. The abrasive polymeric fibers may be arranged in a non-uniform distribution. In another embodiment, the abrasive layer comprises an abrasive foam such as an open-celled melamine foam, and may comprise a thin layer of such foam adhesively attached to a reinforcing layer or to the liquid absorbent layer, according to the principles taught in commonly owned copending application U.S. Ser. No. 10/744238, “Multi-Purpose Cleaning Product Including a Foam and a Web,” filed Dec. 22, 2003 by Chen et al., herein incorporated by reference. Suitable abrasive foam, by way of example, is marketed as BASOTEC® foam by BASF AG (Ludwigshafen, Germany).

Overall, the cleaning product may have an ambient thickness of at least 4 mm, such as at least 8 mm, at least 12 mm, and, in one embodiment, may have an ambient thickness of at least 16 mm. As used herein, the term “ambient thickness” refers to the thickness of the cleaning product at ambient conditions. For commercially available products, the ambient thickness of the product is the “out of package thickness” of the product or the thickness of the product at the point of purchase. Thus, when measuring ambient thickness, the cleaning product may contain some moisture. At the above thicknesses, of particular advantage, the cleaning product may have a relatively low dry mass due to the type of materials used to form the product. For instance, the cleaning product may have a dry mass of less than about 12 grams, such as less than about 11 grams.

The cleaning product may have a total water absorption of at least about 6 g per gram mass, such as at least about 6.25 g per gram mass, at least 6.5 g per gram mass, and in one embodiment, may have a total water absorption of at least 6.75 g per gram mass.

Cleaning products made in accordance with the present invention are easily compressed when wet, while springing back to their original shape after being compressed. The cleaning products may have a wet compressive modulus, for instance, of less than about 3.5 N/mm, such as less than about 3.2 N/mm, or less than about 3.0 N/mm.

When wet, due to the sponge-like member, the cleaning product does not become smaller as may be the case in various prior art products. In fact, cleaning products made according to the present invention may have a ratio of wet thickness to ambient thickness of greater than about 1.1, such as greater than about 1.2 or greater than about 1.3. As used herein, the term “wet” refers to the wetted, saturated condition of the product after saturation as described in the test method section.

The cleaning product of the present invention may be useful in many different applications. For instance, a cleaning pad could be useful as a dishcloth, a scouring pad, a sponge, a polishing pad, a sanding pad, or a personal cleansing pad, such as an exfoliating pad, an applicator for cosmetics and skin-health agents, etc. In addition, the scrubbing product can be part of a cleaning tool useful for cleaning floors, walls, windows, toilets, and the like. In certain embodiments, the cleaning product does not comprise an abrasive layer, but comprises a sponge-like layer and additional fibrous layers such as resilient tissue webs to provide absorbent and cleaning benefits.

### DEFINITIONS

As used herein the term “spunbond fibers” refers to small diameter fibers of molecularly oriented polymeric material. Spunbond fibers may be formed by extruding molten thermoplastic material as filaments from a plurality of fine, usually circular capillaries of a spinneret with the diameter of the extruded filaments then being rapidly reduced as in, for example, U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, U.S. Pat. No. 3,542,615 to Dobo et al, and U.S. Pat. No. 5,382,400 to Pike et al. Spunbond fibers are generally not tacky when they are deposited onto a collecting surface and are generally continuous. Spunbond fibers are often about 10 microns or greater in diameter. However, fine fiber spunbond webs (having an average fiber diameter less than about 10 microns) may be achieved by various methods including, but not limited to, those described in commonly assigned U.S. Pat. No. 6,200,669 to Marmon et al. and U.S. Pat. No. 5,759,926 to Pike et al., each is hereby incorporated by reference in its entirety.

As used herein, the term “multicomponent fibers” refers to fibers or filaments which have been formed from at least two polymers extruded from separate extruders but spun together to form one fiber. Multicomponent fibers are also sometimes referred to as “conjugate” or “bicomponent” fibers or filaments. The term “bicomponent” means that there are two polymeric components making up the fibers. The polymers are usually different from each other, although conjugate fibers may be prepared from the same polymer, if the polymer in each component is different from one another in some physical property, such as, for example, melting point or the softening point. In all cases, the polymers are arranged in substantially constantly positioned distinct zones across the cross-section of the multicomponent fibers or filaments and extend continuously along the length of the multicomponent fibers or filaments. The configuration of such a multicomponent fiber may be, for example, a sheath/core arrangement, wherein one polymer is surrounded by another, a side-by-side arrangement, a pie arrangement or an “islands-in-the-sea” arrangement. Multicomponent fibers are taught in U.S. Pat. No. 5,108,820 to Kaneko et al.; U.S. Pat. No. 5,336,552 to Strack et al.; and U.S. Pat. No. 5,382,400 to Pike et al.; the entire content of each is incorporated herein by reference. For two component fibers or filaments, the polymers may be present in ratios of 75/25, 50/50, 25/75 or any other desired ratios.

As used herein, the term “hydroentangled web” refers to a high pulp content nonwoven composite fabric. The composite fabric contains more than 50%, such as more than 70%, by weight pulp fibers which are hydraulically entangled into a continuous filament substrate, such as a spunbond substrate. Examples of hydroentangled webs are disclosed in U.S. Pat. No. 5,284,703, which is incorporated herein by reference.

As used herein, the term “coform web” refers to a material produced by combining separate polymer and additive streams into a single deposition stream in forming a nonwoven web. Such a process is taught, for example, by U.S. Pat. No. 4,100,324 to Anderson, et al. which is hereby incorporated by reference.

As used herein the term “meltblown fibers” means fibers of a polymeric material which are generally formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter. Thereafter, the meltblown fibers may be carried by the high velocity gas stream and are deposited on a collecting surface to form a web of randomly dispersed meltblown fibers. Meltblown fibers may be continuous or discontinuous and are generally tacky when deposited onto a collecting surface. In some embodiments, however, low or minimal air flow is used to reduce fiber attenuation and, in some embodiments, to permit neighboring filaments of molten polymer to coalesce (e.g., to adhere along the respective sides of the strands), becoming joined at least in part along the proximate sides of the neighboring strands to form fibers that are multifilamentary aggregate fibers (i.e. an aggregate fiber formed of two or more polymer strands further defined herein).

As used herein, “high yield pulp fibers” are those papermaking fibers produced by pulping processes providing a yield of about 65 percent or greater, more specifically about 75 percent or greater, and still more specifically from about 75 to about 95 percent. Yield is the resulting amount of processed fiber expressed as a percentage of the initial wood mass. Such pulping processes include bleached chemithermomechanical pulp (BCTMP), chemithermomechanical pulp (CTMP) pressure/pressure thermomechanical pulp (PTMP), thermomechanical pulp (TMP), thermomechanical chemical pulp (TMCP), high yield sulfite pulps, and high yield kraft pulps, all of which leave the resulting fibers with high levels of lignin. High yield fibers are well known for their stiffness (in both dry and wet states) relative to typical chemically pulped fibers. The cell wall of kraft and other non-high yield fibers tends to be more flexible because lignin, the “mortar” or “glue” on and in part of the cell wall, has been largely removed. Lignin is also nonswelling in water and hydrophobic, and resists the softening effect of water on the fiber, maintaining the stiffness of the cell wall in wetted high yield fibers relative to kraft fibers. The preferred high yield pulp fibers may also be characterized by being comprised of comparatively whole, relatively undamaged fibers, high freeness (250 Canadian Standard Freeness (CSF) or greater, more specifically 350 CSF or greater, and still more specifically 400 CSF or greater, such as from about 500 to 750 CSF), and low fines content (less than 25 percent, more specifically less than 20 percent, still more specifically less that 15 percent, and still more specifically less than 10 percent by the Britt jar test). In addition to common papermaking fibers listed above, high yield pulp fibers also include other natural fibers such as milkweed seed floss fibers, abaca, hemp, cotton and the like.

As used herein, the term “cellulosic” is meant to include any material having cellulose as a significant constituent, and specifically comprising about 20 percent or more by weight of cellulose or cellulose derivatives, and more specifically about 50 percent or more by weight of cellulose or cellulose derivatives. Thus, the term includes cotton, typical wood pulps, nonwoody cellulosic fibers, cellulose acetate, cellulose triacetate, rayon, viscose fibers, thermomechanical wood pulp, chemical wood pulp, debonded chemical wood pulp, lyocell and other fibers formed from solutions of cellulose in NMMO, milkweed, or bacterial cellulose, lyocell, and may be viscose, rayon, and the like. Fibers that have not been spun or regenerated from solution may be used exclusively, if desired, or at least about 80% of the web may be free of spun fibers or fibers generated from a cellulose solution. Examples of cellulosic webs may include known tissue material or related fibrous web, such as wetlaid creped tissue, wetlaid uncreped tissue, pattern-densified or imprinted tissue such as Bounty® paper towels or Charmin® toilet paper made by Procter and Gamble (Cincinnati, Ohio), facial tissue, toilet paper, dry-laid cellulosic webs such as airlaid webs comprising binder fibers, coform webs comprising at least 20% papermaking fibers or at least 50% papermaking fibers, foam-formed tissue, wipes for home and industrial use, hydroentangled webs such as spunbond webs hydroentangled with papermaking fibers, exemplified by the webs of U.S. Pat. No. 5,284,703, issued Feb. 8, 1994 to Everhart et al., and U.S. Pat. No. 4,808,467, issued Feb. 28, 1989 to Suskind et al., and the like. In one embodiment, the cellulosic web can be a reinforced cellulosic web comprising a synthetic polymer network such as a spunbond web to which papermaking fibers are added by lamination, adhesive bonding, or hydroentangling, or to which an adhesive such as latex has been impregnated into the web (e.g., by gravure printing or other known means, exemplified by the VIVA® paper towel of Kimberly-Clark Corp., Dallas, Tex.) to provide high wet or dry tensile strength to the web. The reinforcing polymer (including adhesive) may comprise at about 1% or greater of the mass of the cellulosic web, or any of the following: about 5% or greater, about 10% or greater, about 20% or greater, about 30% or greater, or about 40% or greater, of the mass of the cellulosic web, such as from about 1% to about 50% or from about 3% to about 35% of the mass of the cellulosic web.

“Overall Surface Depth” is a measure of the topography of a surface, indicative of a characteristic height different between elevated and depressed portions of the surface. The optical technique used for measuring Overall Surface Depth is described in U.S. Pat. No. 6,749,719 which is incorporated herein by reference.

### BRIEF DESCRIPTION OF THE FIGURES

A full and enabling disclosure of the present invention, including the best mode thereof to one of ordinary skill in the art, is set forth more particularly in the remainder of the specification, including reference to the accompanying figures in which:

FIG. 1 is a perspective view with cutaway portions of one embodiment of a cleaning product made in accordance with the present invention;

FIG. 2 is a cross-sectional view of the cleaning pad illustrated in FIG. 1;

FIG. 3 is a perspective view with cutaway portions of an alternative embodiment of a cleaning pad made in accordance with the present invention;

FIG. 4 is a cross-sectional view of the cleaning pad illustrated in FIG. 3;

FIG. 5 is a perspective view with cutaway portions of still another alternative embodiment of a cleaning pad made in accordance with the present invention; and

FIGS. 6A, 6B and 6C are illustrations of the plate fixtures used during the Wet Compressive Modulus Test as described in the examples.

Repeat use of reference characters in the present specification and drawings is intended to represent same or analogous features or elements of the present invention.

### DETAILED DESCRIPTION OF PREFERRED EMBODIMENTS

Reference now will be made in detail to the embodiments of the invention, one or more examples of which are set forth below. Each example is provided by way of explanation of the invention, not limitation of the invention. In fact, it will be apparent to those skilled in the art that various modifications and variations may be made in the present invention without departing from the scope or spirit of the invention. For instance, features illustrated or described as part of one embodiment, may be used on another embodiment to yield a still further embodiment. Thus, it is intended that the present invention cover such modifications and variations as come within the scope of the appended claims and their equivalents.

In general, the present invention is directed to disposable cleaning pads which are suitable for use in a wide variety of applications, including household cleaning and personal care applications. For example, the cleaning products of the present invention may be suitable for use as a dishcloth, a scrubber pad, a wet cleaning pad, a general purpose cleaning cloth, a wiping product for cleaning/wiping bathroom surfaces, a wiping product for cleaning/wiping floors, a scouring or polishing pad, a wiping product for waxing/polishing, or a personal care product, such as an exfoliating pad, for instance. In certain embodiments, the cleaning products of the present invention can be used to remove layers of a surface, for example in a sanding or polishing application.

The cleaning products are generally made from multiple layers and multiple materials. When combined, the composite products disclosed have unique combinations of low density in the saturated state, high water absorption capacity per gram of total mass, low compressive modulus in the saturated state, along with lower cost than conventional scrubber sponges made with, for example, viscose cellulose sponge material.

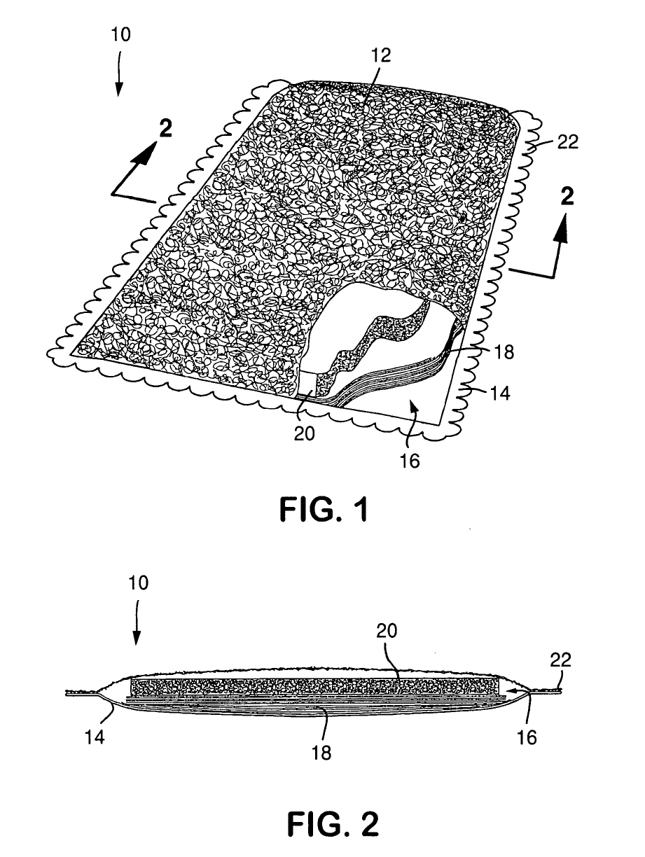

Referring to FIGS. 1 and 2, for instance, one embodiment of a cleaning product generally 10 made in accordance with the present invention is shown. As illustrated, the cleaning product 10 includes an abrasive layer 12 that is attached to a cover layer 14. Inside the cover layer 14 resides a liquid absorbent structure generally 16. In this embodiment, the liquid absorbent structure includes a plurality of cellulosic webs 18 in combination with a sponge-like member 20. Thus, the cleaning product 10 as shown in FIGS. 1 and 2 is generally made from four different materials. Of particular advantage, a wide variety of range of cleaning products is possible by adjusting the relative amounts of each material. For example, it is possible to control the end properties of the cleaning product such as absorbency, thickness, flexibility and wet resilience over a broad range by adjusting the amount of each material in a particular embodiment.

With respect to each layer contained within the cleaning product 10, the abrasive layer 12 is generally used for scrubbing applications where an abrasive material is needed. The abrasive layer 12 may comprise a web treated with abrasive meltblown material, or may be a layer of an abrasive foam such as melamine foam, or may be any other abrasive layer described herein. The outer cover 14 may provide the product with a smooth, wipe-dry side opposite the abrasive layer 12. The plurality of cellulosic webs are contained in the product for a high liquid absorbent capacity and for providing wipe-dry properties in combination with the outer cover 14. The sponge-like member 20, on the other hand, can be not only liquid absorbent, but also provides the product with “spring back” properties. In particular, as will be described in further detail below, the sponge-like member 20 causes the product to spring back to its original shape after wet compression such as when the product is squeezed.

In an alternative embodiment (not shown), the abrasive layer 12 can be replaced by a relatively non-abrasive liquid pervious fibrous layer such as a nonwoven web (e.g., a spunbond web or meltblown web) or a tissue web having high wet strength (e.g., wet tensile ratio to dry tensile ratio is about 0.1 or higher, more specifically about 0.2 or higher, more specifically still about 0.3 or higher).

Materials suitable for constructing the sponge-like member 20 may include materials that exhibit low compressive modulus, high resilience, and high liquid absorptive capacity. In general, the sponge-like member 20 can have a density of less than about 0.08 g/cc, such as from about 0.02 g/cc to about 0.05 g/cc. In various embodiments, for instance, the density of the sponge-like member may be less than about 0.04 g/cc, such as less than about 0.03 g/cc.

As used herein, the density of the sponge-like member is defined as weight in grams divided by volume, which is calculated by multiplying the thickness, width and length of the specimen together. Thickness is measured by placing the sponge-like member between a top and bottom platen at a pressure of 0.2 psi.

The resilience characteristics or the “spring back” characteristics of the sponge-like member 20 may be imparted by using a nonwoven material that has high interfiber bonding and/or fibers of high bending resistence. In one particular embodiment, for instance, the sponge-like member is made from one or more layers of a meltspun web, such as a spunbond web. The spunbond web may be made from relatively high denier multi-component filaments. The denier of the filaments, for instance, may be greater than 2.3 dpf (2.55 dtx). For instance, the denier may be greater than about 3.0 dpf (3.33 dtx) and, in one embodiment, greater than about 4.0 dpf (4.44 dtx). Denier of filaments in a spunbonding process can be adjusted by methods known to those skilled in the art, such as adjusting the polymer through-put, the velocity of the draw air, the orifice size in the spin plate, and the like.

The multi-component filaments of the spunbond nonwoven have a filament configuration that is amenable to thermal crimping processes. The multi-component filaments may be, for instance, bicomponent filaments having two component polymers in a side-by-side or eccentric sheath-core cross-sectional configuration. In particular, the multi-component filaments contain at least two component polymers having different melting points, and the lowest melting component polymer forms at least a portion of the peripheral surface of each of the filaments. For example, the component polymers may have a melting point difference between the highest melting component polymer and the lowest melting component polymer of at least about 5° C., such as at least about 10° C., or, for example such as at least about 30° C. The difference in melting point not only assists in thermally crimping the filaments, but is also used to bond the nonwoven webs together when desired. In particular, when the web is heated to a temperature equal to or higher than the melting point of the lowest melting point component polymer but below the melting point of the highest melting point component polymer, the melted peripheral portions of the filaments form interfiber bonds, especially at the crossover contact points.

The multi-component filaments may be formed from various polymers. Suitable polymers include, for example, polyolefins. Examples of suitable polyolefins include polyethylene, e.g., high density polyethylene, low density polyethylene and linear low density polyethylene; polypropylene, e.g., isotactic polypropylene, syndiotactic polypropylene, and blends of isotactic polypropylene and atactic polypropylene; polybutene, e.g., poly(1-butene) and poly(2-butene); polypentene, e.g., poly(1-pentene), poly(2-pentene), poly(3-mehtyl-1-pentene) and poly(4-methyl-1-pentene); copolymers thereof, e.g., ethylene-propylene copolymers; and blends thereof. Polymers suitable for the other component polymers of the conjugate filaments include above-illustrated polyolefins; polyamides, e.g., nylon 6, nylon 6/6, nylon 10, nylon 12 and the like; polyesters, e.g., polyethylene terephthalate, polybutylene terephthalate and the like; polycarbonates; polystyrenes; thermoplastic elastomers, e.g., ethylene-propylene rubbers, styrenic block copolymers, copolyester elastomers and polyamide elastomers and the like; fluoropolymers, e.g., polytetrafluoroethylene and polytrifluorochloroethylene; vinyl polymers, e.g., polyvinyl chloride; polyurethanes; and blends and copolymers thereof.

Particularly suitable multicomponent filaments are bicomponent filaments that are polyolefin-polyolefin, e.g., polyethylene-polypropylene and polyethylene-polybutylene. Of these pairs, more particularly desirable are polyolefin-polyolefin pairs, e.g., linear low density polyethylene-isotactic polypropylene, high density polyethylene-isotactic polypropylene and ethylene-propylene copolymer-isotactic polypropylene.

In forming the spunbond nonwoven web, the bicomponent filaments are extruded through spinnerets. The process line may also include a quench blower positioned adjacent to a curtain of formed filaments being emitted by the spinneret. Air from the quench air blower quenches the filaments.

A fiber draw unit or aspirator may also be positioned below the spinneret to receive the quenched filaments. The fiber draw unit, for instance, may include an elongate vertical passage through which the filaments are drawn by aspirating air entering from the sides of the passage and flowing downwardly through the passage. In one embodiment, the aspirating air is unheated and is at or about ambient temperature.

From the fiber draw unit, the continuous filaments are directed onto an endless forming surface that may be, for instance, a belt that travels around guide rollers. A vacuum may be positioned below the forming surface to draw the filaments against the forming surface.

Once deposited on the forming surface, the filaments of the nonwoven web are then optionally heat treated by traversal under one of a hot air knife or hot air diffuser. Depending upon the conditions of the hot air diffuser or hot air knife, the filaments may receive an external skin melting or a small degree of bonding during this traversal through the first heating zone. The heat treatment also serves to activate the latent crimp in the filaments.

The filaments are then passed out of the first heating zone of the hot air knife or hot air diffuser to a second wire or belt where the fibers continue to cool. As the filaments cool, the filaments crimp in the Z-direction, or out of the plane of the web, and form a high loft, low density nonwoven web.

If desired, the process line may further include one or more bonding devices such as a through-air bonder. Generally described, a through-air bonder includes a perforated roller which receives the web and a hood surrounding the perforated roller. As the web is conveyed through the through-air bonder, the web is contacted with high temperature air for causing the fibers to fuse together and bond.

When the spunbond filaments are crimped, the web increases in loft and is relatively resilient. The crimp of the filaments creates an open web structure with substantial void portions between filaments. The temperature required to activate the latent crimp of most bicomponent filaments ranges from about 110° F. to a maximum temperature at or about the melting point of the high melting point polymer component. For most applications, controlling the air temperature during crimping controls the degree of crimp that is imparted into the filaments.

By using substantially unheated air in the fiber draw unit as described in the above process, the multi-component filaments are constructed so that they do not crimp in a tight helical fashion. Instead, the filaments more loosely and randomly crimp, thereby imparting more Z-direction loft to the resulting web. In addition to having a more loose and random crimp, the radius of the crimp generally tends to be larger as compared to filaments produced in a heated fiber draw unit. These properties result in a nonwoven web having a higher loft at a given basis weight, lower density at a given basis weight and more uniformity in the resulting nonwoven web when the post formation crimping process is utilized.

In general, the resulting sponge-like spunbond layer has a thickness in excess of about 3 mm, such as from about 4 mm to about 8 mm in one embodiment and from about 5 mm to about 20 mm in a second embodiment.

The basis weight of the spunbond layer is generally greater than about 50 gsm, such as greater than about 100 gsm. For example, in one embodiment, the basis weight may be greater than about 150 gsm, such as greater than about 200 gsm. The spunbond, sponge-like layer may be formed from a single ply or can be constructed by using multiple plies that may optionally be attached together.

When a spunbond, sponge-like layer as described above is incorporated into the cleaning product 10, various advantages and benefits are obtained. For example, the sponge-like member 20 enhances the flexibility and deformability of the product during use. The sponge-like member 20 is also resilient and springs back to its original shape after being squeezed or deformed. The sponge-like member 20 provides absorbency and creates a reservoir to retain liquids during use. The sponge-like layer also provides foaming action in the presence of surfactants and soaps. Finally, the sponge-like member provides conformability to complex contours and protects the hand from sharp or abrasive surfaces being scrubbed. The sponge-like member can also provide a source for delivery of active ingredients that may be encapsulated or impregnated into the material.

For many embodiments, the sponge-like member 20 may comprise at least about 20% by weight of the entire liquid absorbent structure 16 as shown in FIG. 1. For example, the sponge-like member may comprise from about 20% to 100% by weight of the liquid absorbent structure, such as from about 20% to about 50% by weight. In various embodiments, the sponge-like member 20 may comprise at least about 25% by weight of the liquid absorbent structure, such as at least about 30% by weight.

As described above, in one embodiment, the sponge-like member 20 comprises a crimped, spunbond multi-component layer. It should be understood, however, that in other embodiments, different materials may be used. For instance, any suitable fibrous web may be used that has a density of less than about 0.05 g/cc and has resilience characteristics. Examples of sponge-like materials that may be used in the present invention include bonded carded webs or airlaid staple webs that are bonded. Other examples include creped and crimped spunbond webs.

In one embodiment, the sponge-like member 20 may be treated either chemically, mechanically, and/or electrically in order to improve the wettability characteristics of the layer. For example, the sponge-like member 20 may be treated with a wetting agent, may be apertured, or may be subjected to a corona treatment in order to make the material more wettable.

As shown in FIG. 1, in one embodiment, the liquid absorbent structure 16, in addition to the sponge-like member 20 may include a plurality of cellulosic webs 18. The cellulosic webs provide good water absorption properties.

In general, any suitable cellulosic web may be used in the cleaning product 10. For instance, the cellulosic web may be an airlaid web, a coform web, a hydroentangled web, a bonded carded web, a wetlaid web, or mixtures thereof. The cellulosic webs generally should contain high levels of bulk. Further, the webs may have a substantial amount of wet strength and wet resilience for use in wet environments. The cellulosic webs, if desired, may also be highly textured and have a 3-dimensional structure. For instance, the cellulosic web may have an Overall Surface Depth of greater than about 0.2 mm, and particularly greater than about 0.4 mm. In one embodiment, the cellulosic web may be a commercial paper towel, such as a SCOTT® towel or a VIVA® towel. SCOTT® towels, for example, have a wet:dry tensile strength ratio typically greater than 30% and VIVA® towels have a wet:dry tensile strength ratio typically greater than 60%.

In one embodiment, the cellulosic web may comprise a wetlaid paper web that has been textured by being dried in a 3-dimensional state. For example, in one particular embodiment, the fibrous webs may contain uncreped through-air dried webs that have a basis weight, for instance, of from about 10 gsm to about 150 gsm, such as from about 30 gsm to about 80 gsm. The uncreped, through-air dried webs may contain softwood fibers, hardwood fibers, recycled fibers, and high-yield fibers. The amount of high-yield pulp fibers present in the sheet may vary depending upon the particular application. For instance, the high-yield pulp fibers may be present in an amount of about 5 dry weight percent or greater, or specifically about 15 dry weight percent or greater, or more specifically about 50% or greater. In fact, in one embodiment, the web may be made entirely from high-yield pulp fibers. Thus, high-yield pulp fibers may be present in the web in an amount from about 5% by weight to 100% by weight, such as from about 15% by weight to about 80% by weight.

In one embodiment, the uncreped through dried webs may be formed from multiple layers of a fiber furnish. Both strength and softness are achieved through layered webs, such as those produced from stratified headboxes wherein at least one layer delivered by the headbox comprises softwood fibers while another layer comprises hardwood or other fiber types. Layered structures produced by any known means in the art are within the scope of the present invention.

In one embodiment, for instance, a layered or stratified web is formed that contains high-yield pulp fibers in the center. The outer layers of the sheet may then be made from softwood fibers and/or hardwood fibers.

In addition to containing high-yield fibers, the paper web may also contain a wet strength agent to improve wet resiliency. In fact, the combination of non-compressive drying to mold a three-dimensional paper web, coupled with wet strength additives and applying wet resilient fibers produces webs that maintain an unusually high bulk when wet, even after being compressed.

“Wet strength agents” are materials used to immobilize the bonds between the fibers in the wet state. Any material that when added to a paper web or sheet results in providing the sheet with either a wet geometric mean tensile strength/dry geometric tensile strength ratio in excess of 0.1 (the GM wet:dry tensile ratio), or a wet tensile strength/dry tensile ratio in the cross-direction in excess of 0.1 (the CD wet:dry ratio), will, for purposes of this invention, be termed a wet strength agent. Typically these materials are termed either as permanent wet strength agents or as “temporary” wet strength agents. For the purposes of differentiating permanent from temporary wet strength, permanent will be defined as those resins which, when incorporated into paper or tissue products, will provide a product that retains more than 50% of its original wet strength after exposure to water for a period of at least five minutes. Temporary wet strength agents are those which show less than 50% of their original wet strength after being saturated with water for five minutes. Both classes of material find application in the present invention, though permanent wet strength agents are believed to offer advantages when a pad of the present invention is to be used in a wet state for a prolonged period of time.

The amount of wet strength agent added to the pulp fibers may be at least about 0.1 dry weight percent, more specifically about 0.2 dry weight percent or greater, and still more specifically from about 0.1 to about 3 dry weight percent based on the dry weight of the fibers.

Permanent wet strength agents will provide a more or less long-term wet resilience to the structure. In contrast, the temporary wet strength agents would provide structures that had low density and high resilience, but would not provide a structure that had long-term resistance to exposure to water. The mechanism by which the wet strength is generated has little influence on the products of this invention as long as the essential property of generating water-resistant bonding at the fiber/fiber bond points is obtained.

Suitable permanent wet strength agents are typically water soluble, cationic oligomeric or polymeric resins that are capable of either crosslinking with themselves (homocrosslinking) or with the cellulose or other constituent of the wood fiber. The most widely used materials for this purpose are the class of polymer known as polyamide-polyamine-epichlorohydrin (PAE) type resins. Examples of these materials have been sold by Hercules, Inc., Wilmington, Delaware, as KYMENE 557H. Related materials are marketed by Henkel Chemical Co., Charlotte, N.C. and Georgia-Pacific Resins, Inc., Atlanta, Ga.

Polyamide-epichlorohydrin resins are also useful as bonding resins in this invention. Materials developed by Monsanto and marketed under the SANTO RES label are base-activated polyamide-epichlorohydrin resins that may be used in the present invention. Although they are not as commonly used in consumer products, polyethylenimine resins are also suitable for immobilizing the bond points in the products of this invention. Another class of permanent-type wet strength agents is exemplified by the aminoplast resins obtained by reaction of formaldehyde with melamine or urea.

Suitable temporary wet strength resins include, but are not limited to, those resins that have been developed by American Cyanamid and are marketed under the name PAREZ 631 NC (now available from Cytec Industries, West Paterson, N.J.). Other temporary wet strength agents that could find application in this invention include modified starches such as those available from National Starch and marketed as CO-BOND 1000. With respect to the classes and the types of wet strength resins listed, it should be understood that this listing is simply to provide examples and that this is neither meant to exclude other types of wet strength resins, nor is it meant to limit the scope of this invention.

Although wet strength agents as described above find particular advantage for use in connection with this invention, other types of bonding agents may also be used to provide the necessary wet resiliency. They may be applied at the wet end of the basesheet manufacturing process or applied by spraying or printing, etc. after the basesheet is formed or after it is dried.

The amount of cellulosic webs contained in the cleaning product 10 depends upon the particular application, the type of fibrous web being used, in addition to various other factors. In general, the cleaning product 10 may contain at least four layers, such as at least eight layers of the cellulosic fibrous web. In other embodiments, however, the cleaning product may include at least 12 layers, at least 18 layers, and in one embodiment, can contain at least 20 layers. For example, the cleaning product may contain from about 4 to about 20 cellulosic fibrous layers, such as from about 8 to about 16 layers.

The individual cellulosic fibrous webs can be attached or otherwise bonded together in a manner that prevents the webs from delaminating during use. The layers may be bonded together using any suitable adhesive material. For example, adhesive materials include hotmelt adhesives, starch adhesives, binder fibers, and various other adhesive compounds.

As shown in FIG. 1, in addition to the liquid absorbent structure 16, the cleaning product 10 may also include an abrasive layer 12 and optionally a cover layer 14. The abrasive layer 12 may be attached to the cover layer 14, may form part of the cover layer or may be directly attached to the sponge-like member 20. The abrasive layer 12 may include a material which is formed into an open, porous structure and has enough strength and hardness to form a rough, scratchy surface on the pad. Suitable materials are abundant and may be either natural or synthetic materials. Possible exemplary materials may include any known abrasive materials formed into a desired open structure. Possible synthetic materials may be polymeric materials, such as, for instance, meltspun nonwoven webs formed of molten or uncured polymer which may then harden to form the desired abrasive layer. Possible materials may also be selected for enhancement of properties such as flexibility and resiliency in addition to providing abrasive benefits.

Other materials may optionally be used as the abrasive layer of the present invention. For example, other materials used as abrasives in known commercial cleaning products could be used, such as apertured nylon covers, nylon networks, and materials similar to those found in other abrasive products such as, for instance, SCOTCHBRITE pads of 3M Corp. (Minneapolis, Minn.).

The materials and processes used to form the abrasive layer of the scrubbing pad may be chosen and designed with the desired end use of the product in mind. For example, a scrubbing pad designed as a personal care product, such as a face-washing pad, may include an abrasive layer which is softer and less abrasive than a scrubbing pad for use in household cleaning applications. Thus, the raw materials, additives, fiber diameter, layer density and stiffness, etc. may all vary depending on the desired characteristics of the final product.

In one embodiment, the abrasive layer of the scrubbing pad may include a meltspun web, such as may be formed using a thermoplastic polymer material. Generally, any suitable thermoplastic polymer that may be used to form meltblown nonwoven webs may be used for the abrasive layer of the scrubbing pads. A non-exhaustive list of possible thermoplastic polymers suitable for use include polymers or copolymers of polyolefins, polyesters, polypropylene, high density polypropylene, polyvinyl chloride, vinylidene chloride, nylons, polytetrafluoroethylene, polycarbonate, poly(methyl) acrylates, polyoxymethylene, polystyrenes, ABS, polyetheresters, or polyamides, polycaprolactan, thermoplastic starch, polyvinyl alcohol, polylactic acid, such as for example polyesteramide (optionally with glycerin as a plasticizer), polyphenylsulfide (PPS), poly ether ether ketone (PEEK), polyvinylidenes, polyurethane, and polyurea. For instance, in one embodiment, the abrasive layer may include meltblown nonwoven webs formed with a polyethylene or a polypropylene thermoplastic polymer. Polymer alloys may also be used in the abrasive layer, such as alloy fibers of polypropylene and other polymers such as PET. Compatibilizers may be needed for some polymer combinations to provide an effective blend. In one embodiment, the abrasive polymer is substantially free of halogenated compounds. In another embodiment, the abrasive polymer is not a polyolefin, but comprises a material that is more abrasive than say, polypropylene or polyethylene (e.g. having flexural modulus of about 1200 MPa and greater, or a Shore D hardness of 85 or greater).

Thermosetting polymers may also be used, as well as photocurable polymers and other curable polymers.

In addition to being coarse, the fibers of the abrasive layer may have a high elastic modulus, such as an elastic modulus roughly equal to or greater than that of polypropylene such as about 1,000 MPa or greater, specifically about 2,000 MPa or greater, more specifically about 3,000 MPa or greater, and most specifically about 5,000 MPa or greater. By way of example, phenol plastics may have elastic moduli of about 8000 MPa, and a polyamide (nylon 6,6) reinforced with 15% glass fiber has a reported elastic modulus of about 4,400 MPa (whereas the elastic modulus is about 1,800 MPa without the glass reinforcement).

The fibers of the abrasive layers can be elastomeric or non-elastomeric, as desired (e.g., crystalline or semi-crystalline). In addition, the abrasive layer may comprise a mix of elastomeric fibers and non-elastomeric fibers.

For some polymer groups, an increased melting point may correlate with improved abrasive features. Thus, in one embodiment, the abrasive fibers may have a melting point greater than 120° C., such as about 140° C. or greater, about 160° C. or greater, about 170° C. or greater, about 180° C. or greater, or about 200° C. or greater, exemplified by the following ranges: from about 120° C. to about 350° C., from about 150° C. to about 250° C., or from about 160° C. to about 210° C.

In some embodiments, polymers with relatively high viscosity or low melt flow rates may be useful in producing coarse webs for effective cleaning. The melt flow rate of the polymer is measured according to ASTM D1238. While polymers typically used in meltblowing operations may have melt flow rates of about 1000 g/10 min or greater and may be considered in some embodiments of the present invention, in some embodiments the polymers used to produce an abrasive layer may have a melt flow rate according to ASTM D1238 less than 3000 g/10 min or 2000 g/10 min, such as less than about 1000 g/10 min or less than about 500 g/10 min, specifically less than 200 g/10 min, more specifically less than 100 g/10 min, and most specifically less than 80 g/10 min, such as from about 15 g/10 min to about 250 g/10 min, or from about 20 g/10 min to about 400 g/10 min.

Another measure that may be indicative of good abrasive properties is Shore Hardness D, as measured with standard test method ASTM D 1706. In general, suitable polymeric material of the abrasive layer may have a Shore Hardness D of about 50 or greater, such as about 65 or greater, or more specifically, about 70 or greater, or most specifically about 80 or greater. Polypropylene, for example, typically has Shore D hardness values from about 70 to about 80.

In one embodiment, the polymeric material in the abrasive layer may have a flexural modulus of about 500 MPa or greater and a Shore D hardness of about 50 or greater. In an alternative embodiment, the polymeric material may have a flexural modulus of about 800 MPa or greater and a Shore D hardness of about 50 or greater.

In one embodiment, the polymeric fibers of the abrasive layer are substantially free of plasticizers, or may have 33 weight percent plasticizer or less, more specifically about 20 weight percent plasticizer or less, more specifically about 3 weight percent plasticizer or less. The dominant polymer in the polymeric fibers may have a molecular weight of any of the following: about 100,000 or greater, about 500,000 or greater, about 1,000,000 or greater, about 3,000,000 or greater, and about 5,000,000 or greater.

The abrasive layer may comprise fibers of any suitable cross-section. For example, the fibers of the abrasive layer may include coarse fibers with circular or non-circular cross-sections. Moreover, non-circular cross-sectional fibers may include grooved fibers or multi-lobal fibers such as, for example, “4DG” fibers (specialty PET deep grooved fibers, with an eight-legged cross-section shape). Additionally, the fibers may be single component fibers, formed of a single polymer or copolymer, or may be multi-component fibers.

In an effort to produce an abrasive layer having desirable combinations of physical properties, in one embodiment, nonwoven polymeric fabrics made from multi-component or bicomponent filaments and fibers may be used.

In one embodiment, the abrasive layer comprises metallocene polypropylene or “single site” polyolefins for improved strength and abrasiveness. Exemplary single-site materials are available from H.B. Fuller Company, Vadnais Heights, Minn.

In another embodiment, the abrasive layer includes a precursor web comprising a planar nonwoven substrate having a distribution of attenuated meltable thermoplastic fibers such as polypropylene fibers thereon. The precursor web may be heated to cause the thermoplastic fibers to shrink and form nodulated fiber remnants that impart an abrasive character to the resultant web material. The nodulated fiber remnants may comprise between about 10% and about 50% by weight of the total fiber content of the web and may have an average particle size of about 100 micrometers or greater. In addition to the fibers that are used to form nodulated remnants, the precursor web may contain cellulosic fibers and synthetic fibers having at least one component with a higher melting point than polypropylene to provide strength. The precursor web may be wet laid, air laid, or made by other methods. In one embodiment, the precursor web is substantially free of papermaking fibers. For example, the precursor web may be a fibrous nylon web containing polypropylene fibers (e.g., a bonded carded web comprising both nylon fibers and polypropylene fibers).

The material used to form the abrasive layer may also contain various additives as desired. For example, various stabilizers may be added to a polymer, such as light stabilizers, heat stabilizers, processing aides, and additives that increase the thermal aging stability of the polymer. Further, auxiliary wetting agents, such as hexanol, antistatic agents such as a potassium alkyl phosphate, and alcohol repellants such as various fluoropolymers (e.g., DuPont Repellent 9356H) may also be present. Desired additives may be included in the abrasive layer either through inclusion of the additive to a polymer in the die or alternatively through addition to the abrasive layer after formation, such as through a spraying process.

In one embodiment of the present invention, the abrasive layer 12 comprises a meltblown web. The abrasiveness of the meltblown web may be increased through various techniques. For example, the meltblown web may be formed on a 3-dimensional forming surface under pressure to add texture to the web.

In the manufacture of conventional meltblown materials, high velocity air is usually used to attenuate the polymeric strands to create fine, thin fibers. In the present invention, by adjusting the air flow system, such as by increasing the air flow area or otherwise decreasing the velocity of the air stream immediately adjacent the molten polymeric strands as they emerge from a meltblown die head, it is possible to prevent substantial attenuation of the fiber diameter (or reduce the degree of fiber attenuation). Limiting the attenuation of the fiber diameter may increase fiber coarseness, which may increase the abrasiveness of the layer formed by the fibers.

Additionally, the airflow near the die exit may be used to agitate and spread the polymeric fibers in a manner than may be highly non-uniform on the forming belt. The large degree of non-uniformity of the lay-down of coarse meltblown fibers on the belt may be manifest in a web which may display variations in thickness and variations in basis weight across the surface of the web, i.e., an uneven surface may be created on the web, which may increase the abrasiveness of the layer formed by the fibers.

In addition, non-uniform spread of the fibers during formation of the web may create a web with increased void space within the web. For example, an open network of fibers may be formed which may have open voids that occupy a substantial portion of the layer. For instance, the void volume of the abrasive layer may be greater than about 10%, particularly greater than about 50%, and more particularly greater than about 60% of the volume of the material. These open void materials may inherently have good scrubbing properties.

The abrasive layer may also have a relatively open structure that provides high permeability, allowing gas or liquid to readily pass through the abrasive layer. Permeability can be expressed in terms of Air Permeability measured with the FX 3300 Air Permeability device manufactured by Textest AG (Zurich, Switzerland), set to a pressure of 125 Pa (0.5 inches of water) with the normal 7-cm diameter opening (38 square centimeters), operating in a TAPPI conditioning room (73° F., 50% relative humidity). The abrasive layer may have an Air Permeability of any of the following: about 100 CFM (cubic feet per minute) or greater, about 200 CFM or greater, about 300 CFM or greater, about 500 CFM or greater, or about 700 CFM or greater, such as from about 250 CFM to about 1500 CFM, or from about 150 CFM to about 1000 CFM, or from about 100 CFM to about 800 CFM, or from about 100 CFM to about 500 CFM. Alternatively, the Air Permeability of the abrasive layer can be less than about 400 CFM. In cases wherein the abrasive layer has a basis weight less than 150 gsm, multiple plies of the abrasive layer having a combined basis weight of at least 150 may display an Air Permeability of about 70 CFM or greater, or any of the aforementioned values or ranges given for a single abrasive layer.

In general, thermoplastic polymer fibers in the abrasive layer may be greater than about 30 microns in mean diameter. More specifically, thermoplastic fibers may be between about 40 microns and about 800 microns in mean diameter, such as from about 50 microns to 400 microns, more specifically still from about 60 microns to 300 microns, and most specifically from about 70 microns to about 250 microns. Such fibers are substantially coarser than the fibers of conventional meltblown webs, and the added coarseness is generally helpful in increasing the abrasive characteristics of the web.

The fibers forming the meltblown web may be long enough so as to support the open network of the layer. For example, the fibers may have a fiber length of at least about one centimeter. More specifically, the fibers may have a characteristic fiber length of greater than about 2 cm.

If desired, the fibers may optionally be formed to include abrasion enhancing features, such as inclusion of filler particles, for example microspheres, granules of pumice or metal, treatment with meltblown “shot”, and the like. The fibers may also be optionally treated by addition of polymer emulsions, including acrylic polymers such as Nacrylic ABX 30 available from National Starch and Chemical (Bridgewater, N.J.) to enhance abrasion. However, in an alternative embodiment, the cleaning product or at least the outer surfaces thereof or the abrasive layer thereof (if present) may be substantially free of any one or more of the following: metal, metallized polymers, metal oxides, pumice, mica, talc, titanium dioxide, and filler particles.

Microspheres may be from about 10 microns to about 1 mm in diameter and typically have a shell thickness of from about 1 to about 5 microns, while macrospheres (which may also be used in some embodiments) may have diameters greater than about 1 mm. Such materials may include microbeads of metal, glass, carbon, mica, quartz or other minerals, plastic such as acrylic or phenolic, including acrylic microspheres known as PM 6545 available from PQ Corporation of Pennsylvania, and hollow microspheres such as the cross-linked acrylate SunSpheres™ of ISP Corporation (Wayne, N.J.) and similar hollow spheres as well as expandable spheres such as Expancel® microspheres (Expancel, Stockviksverken, Sweden, a division of Akzo Nobel, Netherlands), and the like.

In one embodiment of the present invention, the abrasive layer may be made from a nonwoven meltspun web, such as a meltblown web treated with a meltblown “shot”. Meltblown shot is a coarse nonuniform layer applied in a meltblown process deliberately operated to generate random globules of the polymer (typically polypropylene or another thermoplastic) interconnected with strands. If desired, the shot may be distinctly colored to make the abrasive element readily visible.

In one embodiment, the abrasive layer of the present invention may include multifilamentary aggregates of individual polymeric strands.

As used herein, the term “multifilamentary aggregate” refers to a meltblown fiber that is actually an aggregate of two or more polymer strands formed by at least the partial coalescence (adhesion) of adjacent molten polymer strands ejected from adjacent holes on a meltblown die, which may be achieved, for example, under circumstances in which the turbulence created by air jets is substantially lower than in normal meltblown operation, thereby allowing two or more adjacent strands to come into contact and become joined together along at least a portion of the length of the strands. For instance, the individual strands forming the multifilamentary aggregate fiber may be joined side by side for a distance greater than about 5 mm, along the length of the fiber. As such, bicomponent fibers, multi-lobal fibers, and the like, which are extruded as a single fiber with multiple polymers or complex shapes are not to be confused with the multifilamentary aggregate fibers of the present invention, which include adjacent polymer strands extruded or ejected from adjacent holes in a meltblown die and only adhere together after exiting the die.

Multifilamentary aggregates may be substantially ribbon-like in character, particularly when three or more strands from adjacent meltblown holes aligned in a line adhere to each other in a substantially parallel array (i.e., parallel to each other with the line formed by connecting the center points of consecutive strands being an approximately straight line). The width of the multifilamentary aggregate may be nearly as great as the number of strands in the multifilamentary aggregates multiplied by the diameter of a single strand, though due to the fusion of portions of the joined strands and due to staggering of the strands in some cases, the width is generally a fraction of the product of the number of strands and the single strand diameter (or average single strand diameter). This fraction may be from about 0.2 to about 0.99, specifically from about 0.4 to about 0.97, more specifically from about 0.6 to about 0.95, and most specifically from about 0.7 to about 0.95. In one embodiment, the major axis of the non-circular multifilament aggregate fiber cross section can be greater than about 30 microns.

The number of strands in the multifilamentary aggregates may range from 2 to about 50, specifically from 2 to about 30, more specifically from 2 to about 20, and most specifically from about 3 to about 12. Multifilamentary aggregates may have a number-weighted average strand count of 3 or more, 4 or more, 5 or more, or 6 or more. A meltblown web comprising multifilamentary aggregates may have multifilamentary aggregates comprising 5% or greater of the mass of the web (such as multifilamentary aggregates with three strands or more comprising 5% or greater of the mass of the web). For example, the mass fraction of the web consisting of multifilamentary aggregates may be about 10% or greater, about 20% or greater, about 30% or greater, about 40% or greater, about 50% or greater, about 60% or greater, about 70% or greater, about 80% or greater, about 90% or greater, or substantially 100%. These ranges may apply to multifilamentary aggregates in general, or to multifilamentary aggregates having at least 3 strands, 4 strands, 5 strands, or 6 strands.

The abrasive layer may have a suitable fiber basis weight and formation so as to provide good scrubbing characteristics to the composite pad structure while remaining flexible. For example, a meltblown web forming the abrasive layer may have a basis weight of greater than about 10 gsm. More specifically, the meltblown web may have a basis weight of between about 25 gsm and about 400 gsm, more specifically between about 30 gsm and about 200 gsm, and most specifically between about 40 gsm and 160 gsm. The meltblown web may have a density ranging from any of about 0.02 grams/cubic centimeter (g/cc), 0.04 g/cc, 0.06 g/cc, 0.1 g/cc, 0.2 g/cc, 0.4 g/cc, 0.6 g/cc, and 0.8 g/cc to any of about 0.1 g/cc, 0.3 g/cc, 0.5 g/cc, and 1 g/cc (other values and ranges known in the art may also be within the scope of the present invention).

As shown in FIGS. 1 and 2, in one embodiment, the cleaning product 10 can include the outer cover 14 which surrounds the liquid absorbent structure 16. The outer cover 14 may be used, for instance, to further improve the integrity of the overall product. The outer cover may be, for instance, any of the fibrous webs described above. In one particular embodiment, for instance, the outer cover can be made from a hydroentangled web in which a meltspun web, such as a spunbond web, is hydroentangled with pulp fibers. When using a hydroentangled web, the pulp fiber side of the web may form the exterior surface of the cleaning product 10. Alternatively, the synthetic fiber side of the web may also form an exterior surface of the absorbent structure. Of particular advantage, a hydroentangled web, since it contains synthetic fibers, is capable of thermally bonding to itself and other layers in the product. For example, the abrasive layer 12 may be formed directly on the outer cover 14 and thermally bonded thereto. Alternatively, the abrasive layer may otherwise be adhesively attached to the outer cover.

As particularly shown in FIG. 1, the edges of the outer cover 14 may be thermally bonded together in order to form a seam 22. In this embodiment, the liquid absorbent structure 16 may “float” within the outer cover or may be adhesively attached to the outer cover if desired.

When using a hydroentangled web as the outer cover, the hydroentangled web may have a basis weight of from about 50 gsm to about 120 gsm.

As shown in FIG. 1, in one embodiment, the sponge-like member 20 of the liquid absorbent structure 16 may be placed adjacent to the abrasive layer 12, while the plurality of cellulosic webs 18 may be placed adjacent to the opposite side of the sponge-like member. In this manner, the sponge-like layer and the abrasive layer form a scrubbing side of the product, while the plurality of cellulosic webs form a wipe-dry side of the product. In other embodiments, however, it should be understood, that the position of the sponge-like member may be reversed with respect to the plurality of cellulosic webs and also the sponge-like member may be positioned with any number of cellulosic webs adjacent to top and bottom of sponge-like member.

The relative sizes of the sponge-like member 20 in comparison to the plurality of cellulosic webs 18 and the abrasive layer 12 may also vary depending upon the particular application and the desired result. For example, in one embodiment, the sponge-like member may be smaller in dimension than the plurality of cellulosic webs and/or smaller in dimension than the abrasive layer. Alternatively, the cellulosic webs may be smaller than the other layers. In still another embodiment, the abrasive layer may cover only a portion of the exterior surface area of one side of the liquid absorbent structure.

In addition to the components or layers shown in the cleaning product 10 of FIG. 1, various other materials and layers may be present if desired. For example, in one embodiment, a liquid impervious barrier layer may be formed in the product. The barrier layer may, for instance, be positioned in between the sponge-like member 20 and the plurality of cellulosic webs 18. In this manner, liquids contacting one surface do not come in contact with the hands of the user. The barrier layer may be, for instance, a film, a woven layer, a nonwoven layer, a laminate, and the like. For example, the barrier material may be a sheet of plastic film such as polyethylene, polypropylene, polyvinyl chloride or similar material.

The cleaning product of the present invention may also contain additional materials, e.g. active ingredients, within the layers as well as additional functional layers or components. For example, a portion of the pad may provide a soap, detergent, waxes or polishing agents such as furniture polish, metal cleaners, leather and vinyl cleaning or restoration agents, stain removers for rubbing on clothing, laundry pre-treatment solutions, enzymatic solutions for improved cleaning or fabric conditioning, odor control agents such as the active ingredients of Fabreze® odor removing compound (Procter and Gamble, Cincinnati, Ohio), water proofing compounds, shoe polish, dyes, glass cleaner, antimicrobial compounds, wound care agents, lotions and emollients, and the like. Other possible additives that may be added to the pad include buffering agents, antimicrobials, skin wellness agents such as lotions, medications (i.e. anti-acne medications), or hydrophobic skin barriers, odor control agents (e.g., zeolites, cyclodextrin derivatives, activated carbon, nanoemulsions such as those described in U.S. Pat. No. 6,506,803 issued Jan. 14, 2003 to Baker et al. and U.S. Pat. No. 6,635,676, issued Oct. 21, 2003 to Baker et al.), surfactants, mineral oil, glycerin and the like.

In one embodiment, the cleaning product can be substantially free of any one or more of the following: lotions, medications, perfumes, fragrances, bleaching agents, oxidants, antimicrobials, latex, natural latex, proteins, animal derivatives, halogenated compounds, and metallized particles or films.

The active ingredients may be present in a solution on the wipe as it is packaged or in a solution that is added to the wipe prior to use. Active ingredients can also be present as a dry powder attached to fibers in the wipe, or as a dry compound impregnated in the fibers or in void spaces between the fibers of the wipe, or encapsulated in water-soluble capsules, encapsulated in waxy or lipid-rich shells to permit escape upon mechanical compression or shear, or in a container attached to or cooperatively associated with the wipe that may be opened during use or prior to use.

As can be appreciated, the cleaning product 10 as shown in FIG. 1 can be hand-held or attached to a device during cleaning and polishing processes. For example, in one embodiment, the cleaning product 10 can be shaped to fit onto a mop or smaller, hand-held scrubbing device. The cleaning product 10 may be held onto the device by any method that can firmly hold the pad, yet, in one embodiment, can release the pad for replacement quickly and easily.

The cleaning tool of the present invention can be used to clean or scrub many different surfaces, and can be designed for a specific use. For example, the cleaning tool can have a handle including a long wand and be used to clean floors, walls, ceilings, ceiling fans, light fixtures, windows and the like. In certain embodiments, such as when the cleaning tool is used to clean windows, for example, the cleaning tool can have a squeegee attachment, such as a rubber material squeegee attached to a surface as is generally known in the art. In other embodiments, the abrasive layer on the cleaning tool can be used for sanding or polishing a surface to be cleaned.

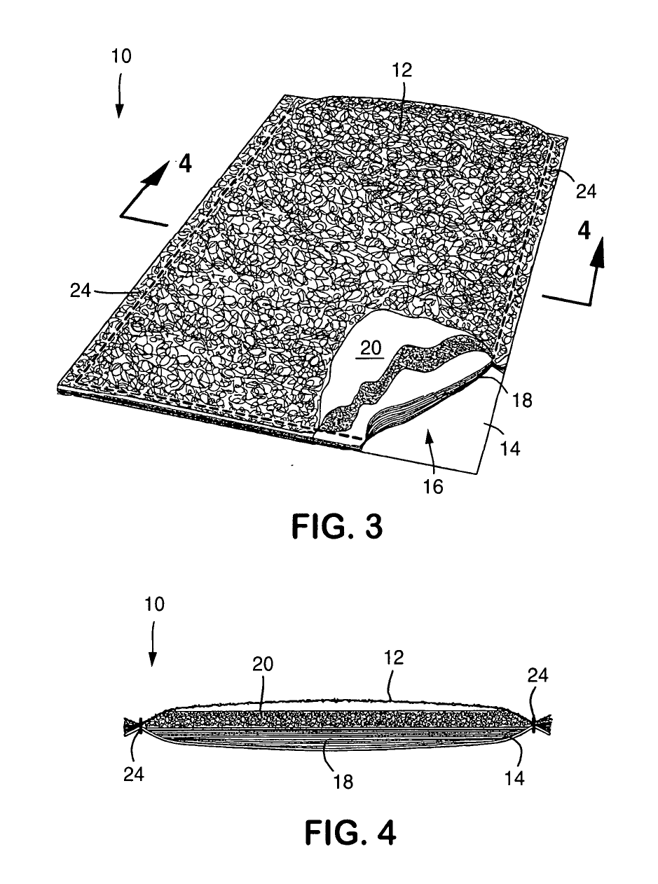

Referring to FIGS. 3 and 4, an alternative embodiment of a cleaning product 10 made in accordance with the present invention is shown. Like reference numerals have been used to indicate similar elements.

Similar to the embodiments shown in FIG. 1, cleaning product 10 as shown in FIGS. 3 and 4 includes an abrasive layer 12, a cover layer 14, and a liquid absorbent structure 16 containing a plurality of cellulosic webs 18 and a sponge-like member 20.

In this embodiment, however, instead of including a thermally fused seam, the layers of the cleaning product 10 are held together by a plurality of stitches 24. As shown, stitches 24 penetrate through each layer. In certain embodiments, the use of stitches 24 may increase the integrity of the overall product.

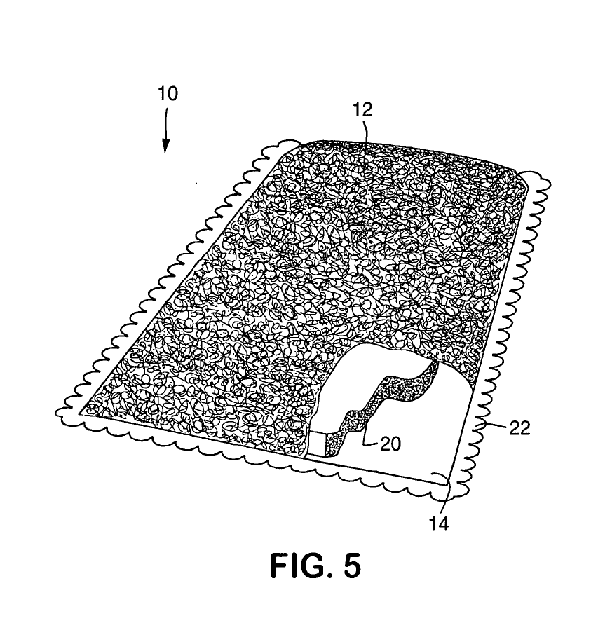

Still another embodiment of a cleaning product 10 made in accordance with the present invention is shown in FIG. 5. Again, like reference numerals have been used to indicate similar elements. The cleaning product shown in FIG. 5 is similar to the cleaning product shown in FIG. 1 except that the cleaning product 5 does not include a plurality of cellulosic webs 18. Instead, the liquid absorbent structure is comprised solely of a sponge-like member 20.

In FIG. 5, the cleaning product 10 includes a cover layer 14 that envelopes the sponge-like member 20. In an alternative embodiment, however, the abrasive layer 12 may be adhered directly to the sponge-like member 20. In this embodiment, the product may not contain a cover layer. The abrasive layer 12 may be connected to the sponge-like member 20 by using an adhesive or, may be thermally bonded to the sponge-like member.

Cleaning products made according to the present invention have been found to possess a unique combination of properties that provide various benefits and advantages. For example, the products have been found to have good water absorption while being able to spring back and retain their shape after being squeezed. Of particular advantage, good water absorption properties are obtained for materials having a relatively low mass.

For example, in one embodiment, cleaning products made in accordance with the present invention may have a total water absorption of at least 6.0 g per gram mass, such as greater than about 6.25 g per gram mass, such as greater than about 6.5 g per gram mass. In one particular embodiment, for instance, the cleaning product may have a total water absorption of greater than 6.75 grams per gram mass.

The cleaning product can have the above water absorption properties while having a dry mass of less than about 12 grams, such as less than about 11 grams. The product may have a relatively small ambient thickness or out of the package thickness that expands when the product becomes wet. For instance, the product may have a ambient thickness of less than about 16 mm, such as less than about 12 mm or, in one embodiment, even less than 8 mm. For example, the ambient thickness of the product may range from about 4 mm to 16 mm. In other embodiments, however, it should be appreciated that the ambient thickness can be much more depending upon the particular end use application.

The product may possess a ratio of wet thickness to ambient thickness of greater than about 1.1, such as greater than about 1.2. For example, in one embodiment, the ratio of wet thickness to ambient thickness may be greater than about 1.3 demonstrating that the product expands when becoming wet. This provides the advantage of packaging a relatively thin product that later increases in size during use.

The present invention may be better understood with respect to the following example.

### EXAMPLE

The following commercially available products were compared with a cleaning product made in accordance with the present invention: SCOTCHBRITE Heavy Duty Scrub Sponge, marketed by 3M; O-CELLO Heavy Duty Sponge Scrubber, marketed by 3M; DOBIE Cleaning Pad, marketed by 3M; SCRUB-IT Scrub Sponges, marketed by Supply Plus; CLOROX S.O.S. Scrubber Sponge, marketed by the Clorox Company; CHORE BOY LONG LAST Scrubbing Sponge, marketed by Reckitt Benckiser, Inc. and DOBIE Easy Grip Scrubber, marketed by 3M.

The cleaning product of the present invention (Example No. 1 below) contained an abrasive layer made from a polypropylene meltblown web. The meltblown web was ultrasonically bonded to a cover layer comprising a hydroentangled web (Wypall® X-70 wiper available from Kimberly-Clark) having a basis weight of about 82 gsm.

The cleaning product of the present invention contained an absorbent core that comprised a sponge-like member comprising a 6 osy bicomponent spunbond web. The filaments contained in the web were crimped after the web was formed as described above. The absorbent core further included 16 layers of 30 gsm uncreped through-air dried webs. The stack of 16 layers of uncreped through-air dried webs were compressed to approximately 1.5 to 2.5 mm thickness. In this embodiment, the absorbent core itself was connected together by a loose buttonhole stitching at six points.

The cleaning product of the present invention contained a second outer cover layer comprised of a hydroentangled web having a basis weight of about 82 gsm.

Further, the two layers of the outer cover were ultrasonically bonded together to form a seam.

The following tests were performed on each of the products listed above. It is important to conduct the tests in a sequential manner as described below, A-B-C-D.

A. Out of Package Dimensions Test

This test is conducted with the out of package specimens. All testing should be done under TAPPI conditions (50% relative humidity and 23° C.).

Sample Preparation:

Place a mark centered on each of the four longitudinal sides 10 mm inboard of the edge of the specimen (numbers 2-5 below). Also place a mark in the center of the specimen (# 1) in figure below.
   Procedure:
1. Using the Mitutoyo digital caliper device model CD-6″ CS, measure specimen length and width holding the caliper grips perpendicular to the specimen (not tilted). The caliper grips should just make contact with, and not compress the specimen. Take one reading per dimension (both length and width). Record the results in millimeters.
2. To measure thickness, take one reading from each of the five locations indicated below recording the results in millimeters. Again, the caliper grips should just make contact with, and not compress the specimen.
   Note: The measurement should be taken just prior to any deformation of material. This generally refers to 0.05 psi or less pressure. 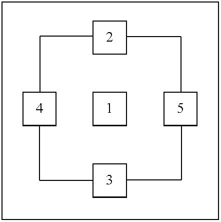
3. Add all of the thickness measurements obtained when measuring the dry specimen and divide by five to obtain the average thickness for the specimen for the out of package state.
   B. Water Absorption Test—Dip & Drip

This test immediately follows the out of package dimensions test describe above in A. Only de-ionized or distilled water conditioned under TAPPI specifications is used. This testing begins once the initial dimensions have been taken. Once this test is completed and the specimen has been wetted, dimension testing is repeated and wet thickness is reported as described above. All testing is conducted in TAPPI conditions (50% relative humidity and 23° C.).

Testing Preparation:

1. Fill a container to a depth of at least 1″ greater than the thickest specimen to be tested. This water level should be maintained for each specimen tested.
2. Place another pan capable of capturing displaced water from the specimen adjacent to the water filled pan.
3. Adjacent to the pan for displaced water is a calibrated balance capable of measuring to the nearest hundredth of a gram.
4. A timing mechanism which is able to display time in increments of seconds, such as a stopwatch, is needed.
   Procedure:
1. Place the out of package specimen onto the scale and record the mass to the nearest hundredth of a gram (out of package mass).
2. Completely submerge the specimen in the pan of water (if there is an abrasive side it should be proximal to the hand) with very light pressure from your fingertips.
3. Press the specimen under water for 30 seconds, verified through the stopwatch or other timing device.
4. Remove the specimen from the pan of water by lightly grasping the corner between dimension points 2 and 5 (above). The specimen should be held such that the diagonal dimension between the corners is parallel with gravity. Place the specimen over the water capturing pan for 30 seconds, verified by the stopwatch or other timing device.
5. Following the 30 seconds, place the specimen on the scale and record the mass to the nearest hundredth of a gram.
6. The final mass minus the initial mass is the absorbent capacity of the specimen.
7. The absorbent capacity mass from step (6) divided by the original mass from step (1) yields the gram per gram water absorption of the specimen.
   C. Wet Dimensions Test

This test is conducted with wetted specimens immediately following the water absorption test described above. All testing should be done under TAPPI conditions (50% relative humidity and 23° C.).

Sample Preparation:

Place a mark centered on each of the four longitudinal sides 10 mm inboard of the edge of the specimen (numbers 2-5 below). Also place a mark in the center of the specimen (# 1) in figure below.
   Procedure:
4. Using the Mitutoyo digital caliper device model CD-6″ CS, measure specimen length and width holding the caliper grips perpendicular to the specimen (not tilted). The caliper grips should just make contact with, and not compress the specimen. Take one reading per dimension (both length and width). Record the results in millimeters.
5. To measure thickness, take one reading from each of the five locations indicated below, recording the results in millimeters. Again, the caliper grips should just make contact with, and not compress the specimen.
   Note: The measurement should be taken just prior to any deformation of material. This generally refers to 0.05 psi or less pressure. 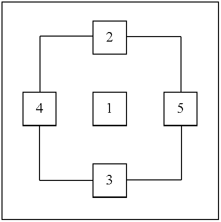
6. Add all of the thickness measurements obtained when measuring the wet specimen and divide by five to obtain the average thickness for the specimen for the wet state.
   D. Wet Compressive Modulus Test
   (Conducted Immediately After the Wet Dimensions Test Described Above in C.)

This test was developed on an MTS Sintech 1/G Model tensile frame using TestWorks 3.0 as the interfacing software package. All testing is done at TAPPI conditions (50% relative humidity and 23° C.).

Procedure:

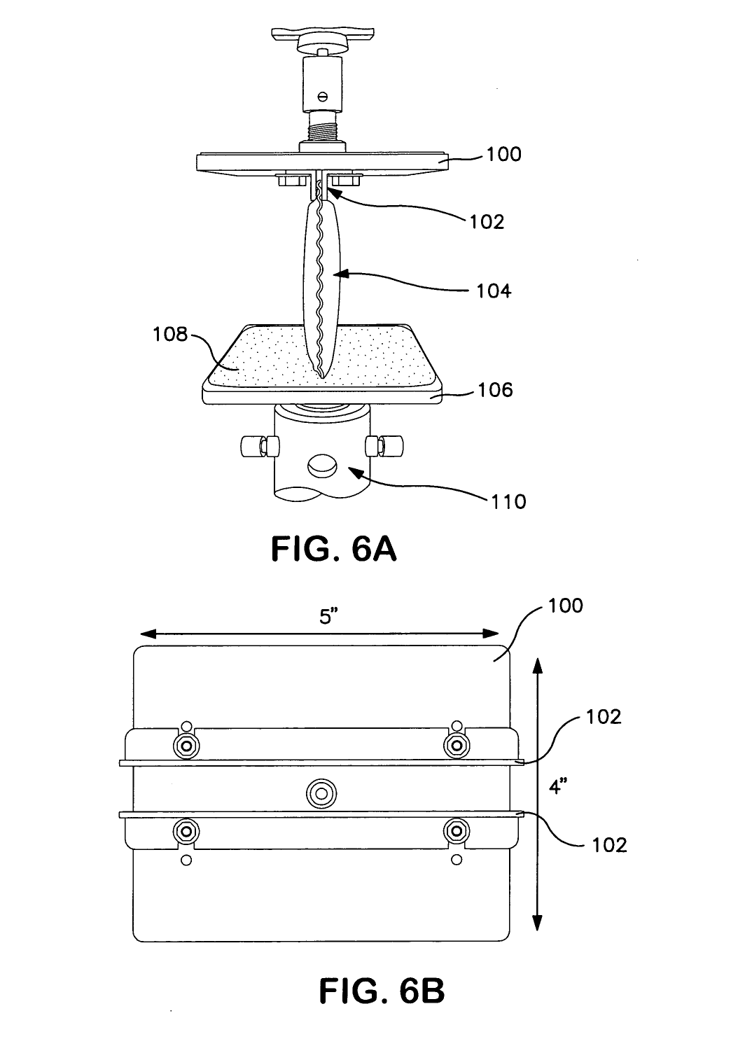

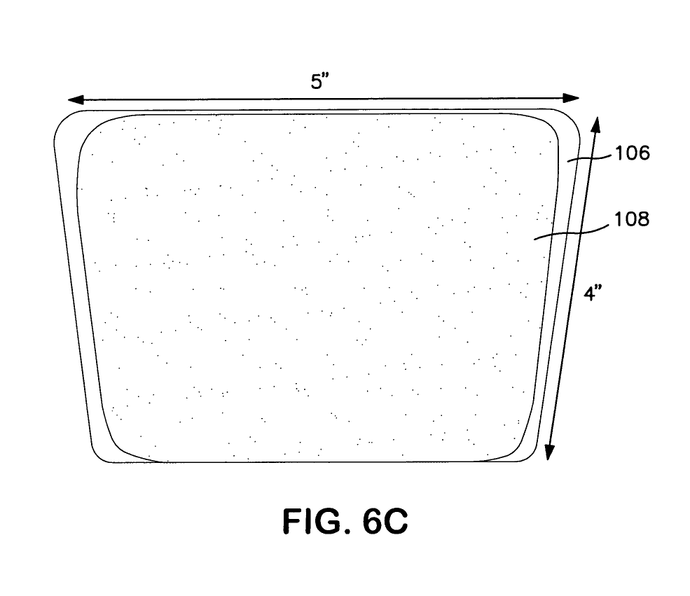

1. Be sure a 100 N load cell is properly placed into the tensile frame.
2. Attach the appropriate compressive plate fixtures as shown in FIGS. 6A, 6B and 6C. These fixtures are designed to fix the specimen 104 perpendicular to two compressive platens between a set of adjustable brackets, where the longest dimension of the specimen is oriented perpendicular to the direction of the compressive force. The upper fixture 100 comprises a compressive platen with two flanges 102 which are extended 7/16″ in the parallel to the compressive plate, and 7/16″ in the direction perpendicular to the compressive plate. These flanges 102 hold the specimen in place during testing by two of set screws which can be locked in position as shown in FIG. 6B. The bottom fixture 106 is a traditional flat compressive platen with a waterproof non-slip surface 108 adhered to it. This waterproof non-slip surface 108 comprises a sandpaper texture of at least as coarse as 100 grit as shown in FIG. 6C. The size of the platens themselves is not of importance to the result of the test, provided they can appropriately accommodate the dimensions of the specimen 104. Both top and bottom fixtures include traditional mating sockets such as 110 for installation into a standard tensile frame.
3. Calibrate the load cell with the compressive fixtures attached.
4. Wrap the area just below the bottom fixtures with paper toweling to capture any water released from compressing the specimen.
5. Lower the crosshead such that the flange of the top fixture and the compressive plate of the bottom fixture are roughly 1 cm apart. Set the safety stop on the tensile frame at this point.
6. Raise the crosshead so that the compressive plates are roughly 6 inches apart, allowing clearance for the insertion of the specimen.
7. Open the compressive test method program. The program consists of a test method written in the TestWorks 3.0 software package which compresses the specimen 35 mm at a crosshead speed of 20.00 inches/minute. Following compression, the crosshead then returns to its original position and a compressive modulus is calculated. In this case, compressive modulus is calculated by TestWorks 3.0 as the maximum ratio of force to displacement, up to the yield point.
8. Remove the top compressive fixture from the tensile frame.
9. Holding the top fixture over a plate to catch excess water, insert the long edge of the specimen between the guides on the top fixture and tighten the guides in place using an allen wrench. This may be done by only loosening one of the guides, putting the sample in place, tightly compressing the specimen between the guides, and tightening the guide in place.
10. Load the top compressive fixture with the specimen attached into the tensile frame.
11. Zero the load cell with the sample loaded in the top fixture.
12. Slowly lower the crosshead down so that the specimen barely touches the bottom compressive plate, corresponding to a force of less than −0.5 N. This point can be determined by observing the live force readout on the TestWorks 3.0 software.
13. Zero the crosshead position.
14. The following Input Parameters should be entered into the software:
   a. Calculation Inputs:
      i. Yield angle: 0.00 deg.
      ii. Yield % Seg/Len 2.00%
      iii. Slope % Seg/Len 2.00%
      iv. Slack Pre-Load 0.50 N
   b. Test Inputs:
      i. Crosshead Speed: 20.00 in/min
      ii. Secondary Speed: 4.00 in/min
      iii. % Strain Limit 100.0%
      iv. Deformation Limit: 200.0%
      v. Load Limit HI: 125 N
      vi. Ex Limit HI: 20.0 in.
      vii. # Cycles: 3
      viii. Hold Time: 5 sec.
      ix. Break Sensitivity: 120%
      x. Compression Distance: 35.0 mm
   Note: The compression distance was changed to 25 mm for the SCRUB-IT product due to its size.
15. After naming the sample, run the tensile method. The test compresses the specimen according to the inputs given, water exits the specimen, and the crosshead returns to its original position.
16. Record the value of compressive modulus, as calculated in step (7).
17. Remove the specimen from the fixtures by loosening the set screws on the top fixture and replace the paper toweling if necessary.

The following results were obtained:

| | | | | Wet | | | |
|---|---|---|---|---|---|---|---|
| | | Out of | | Thickness to | Out of | | Wet |
| | | Package Thickness | Wet | Out of Package | Package | Water | Compressive |
| | | (ambient thickness) | Thickness | Thickness | Mass | Absorption | Modulus |
| | UPC Code # | (mm) | (mm) | N/A | (g) | (gram/gram) | (N/mm) |
| 3M Scotchbrite ® | 2120057235 | 20.4 | 20.9 | 1.03 | 22.2 | 2.9 | 3.7 |
| Heavy Duty Scrub | | | | | | | |
| Sponge | | | | | | | |
| 3M O-Cello Heavy | 5320008163 | 27.3 | 26.9 | .98 | 22.4 | 4.4 | 3.6 |
| Duty Sponge | | | | | | | |
| Scrubber | | | | | | | |
| Dobie ® Cleaning | 2120057263 | 18.2 | 17.8 | .98 | 10.6 | 1.9 | 2.4 |
| Pad | | | | | | | |
| Scrub-It ® Scrub | 7500804122 | 24.4 | 24.0 | .98 | 2.8 | 36.3 | 2.1 |
| Sponges | | | | | | | |
| Clorox S.O.S ® | 4129491028 | 26.6 | 25.9 | .97 | 24.0 | 3.7 | 4.7 |
| Scrubber Sponges | | | | | | | |
| Chore Boy ® Long | 2660074525 | 19.9 | 18.2 | .91 | 11.0 | 4.6 | 4 |
| Last ® Scrubbing | | | | | | | |
| Sponge | | | | | | | |
| Dobie ® Easy Grip | 2120057255 | 41.5 | 40.7 | .98 | 7.5 | 11.1 | 2.1 |
| Scrubber | | | | | | | |
| Example No. 1 | Not Applicable | 12.7 | 17.2 | 1.35 | 8.9 | 6.9 | 2.8 |

As shown above, the cleaning product made according to the present invention had a relatively low ambient thickness. The cleaning product of the present invention, however, expanded in size when wet. This represents a significantly reduced volume for shipping/storage.

The scrubbing pad of the present invention also had a relatively low wet compressive modulus which indicates that the product is easy to squeeze and manipulate during use. Further, the product of the present invention demonstrated good water absorption characteristics at a relatively low dry mass.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A cleaning product comprising:
a liquid absorbent structure comprising:
(a) a plurality of fibrous cellulosic webs; and
(b) a sponge-like member comprised of meltspun filaments, the sponge-like member having a density of less than about 0.08 g/cc and comprising at least 20% by weight of the liquid absorbent structure; and
an abrasive layer attached to the liquid absorbent structure forming an exterior surface of the cleaning product.

2. A cleaning product as defined in claim 1, wherein the sponge-like member comprises at least one layer of a nonwoven material containing spunbond filaments.

3. A cleaning product as defined in claim 2, wherein the spunbond filaments comprise crimped, bicomponent filaments, and wherein the bicomponent filaments comprise about 10% or more of the dry mass of the cleaning product.

4. A cleaning product as defined in claim 3, wherein the bicomponent filaments comprise a polyethylene component and a polypropylene component in a side-by-side relationship.

5. A cleaning product as defined in claim 4, wherein the sponge-like member has a density of less than about 0.04 g/cc.

6. A cleaning product as defined in claim 4, wherein the sponge-like member has a density of less than about 0.03 g/cc.

7. A cleaning product as defined in claim 1, wherein the sponge-like member has a basis weight of at least 100 gsm.

8. A cleaning product as defined in claim 1, wherein the fibrous cellulosic webs comprise uncreped, through-air dried webs, the liquid absorbent structure including at least eight layers of the fibrous cellulosic webs.

9. A cleaning product as defined in claim 1, wherein the fibrous cellulosic webs comprise airlaid webs, coform webs, hydroentangled webs, bonded carded webs, or mixtures thereof.

10. A cleaning product as defined in claim 1, wherein the abrasive layer comprises a meltblown web.

11. A cleaning product as defined in claim 10, wherein about 10% or more of the mass of the meltblown web comprises meltblown fibers having a diameter of at least 40 microns.

12. A cleaning product as defined in claim 10, wherein the meltblown web has a basis weight of at least 50 gsm.

13. A cleaning product as defined in claim 1, wherein the cleaning product contains an additive comprising a soap, a detergent, a buffering agent, an antimicrobial agent, a skin wellness agent, a lotion, a medication, a polishing agent, or mixtures thereof.

14. A cleaning product as defined in claim 1, further comprising a cover layer surrounding the liquid absorbent structure, the cover layer comprising a hydroentangled web.

15. A cleaning product as defined in claim 14, wherein the abrasive layer is attached to the cover layer.

16. A cleaning product as defined in claim 1, wherein the cleaning product has a total water absorption of at least 6.0 g per gram mass, a wet compressive modulus of less than about 3.5 N/mm, an ambient thickness of at least 4 mm, and a ratio of wet thickness to ambient thickness of greater than about 1.1.

17. A cleaning product as defined in claim 1, wherein the cleaning product has a total water absorption of at least 6.75 g per gram mass, a wet compressive modulus of less than about 3.0 N/mm, an ambient thickness of at least 12 mm, and a ratio of wet thickness to ambient thickness of greater than about 1.3.

18. A cleaning product as defined in claim 1, wherein the sponge-like member has been treated chemically, electrically or mechanically in order to increase the rate of water absorption.

19. A cleaning product as defined in claim 1, wherein the cleaning product has a total water absorption of at least 6.0 g per gram mass, a wet compressive modulus of less than about 3.5 N/mm, an ambient thickness of less than about 17 mm, and a ratio of wet thickness to ambient thickness of greater than about 1.1.

20. A cleaning product as defined in claim 1, wherein about 20% or more of the mass of the product comprises meltspun filaments in the sponge-like member, and about 20% or more of the mass of the product comprises cellulosic fibrous material.

21. A cleaning product as defined in claim 1, wherein about 20% or more of the mass of the liquid absorbent structure comprises meltspun filaments in the sponge-like member, and about 20% or more of the mass of the liquid absorbent structure comprises cellulosic fibrous material.

22. A cleaning product as defined in claim 1, further comprising a superabsorbent material.

23. A cleaning product as defined in claim 1, further comprising a second sponge-like member comprising bicomponent fibers.

24. A cleaning product comprising:
a liquid absorbent structure comprising:
(a) a plurality of fibrous cellulosic webs; and
(b) a sponge-like member comprising meltspun filaments, the sponge-like member having a density of less than about 0.08 g/cc and comprising at least 20% by weight of the liquid absorbent structure; and
a fibrous layer attached to the liquid absorbent structure forming an exterior surface of the cleaning product.

25. A cleaning product as defined in claim 24, wherein the sponge-like member comprises at least one layer of a nonwoven material containing spunbond filaments, the spunbond filaments comprising crimped, bicomponent filaments, the bicomponent filaments comprising at least about 10% by weight of the dry mass of the cleaning product.

26. A cleaning product as defined in claim 24, wherein the fibrous cellulosic webs comprise uncreped, through-air dried webs, the liquid absorbent structure including at least eight layers of the fibrous cellulosic webs.

27. A cleaning product as defined in claim 24, wherein the fibrous cellulosic webs comprise airlaid webs, coform webs, hydroentangled webs, bonded carded webs, or mixtures thereof.

28. A cleaning product as defined in claim 24, wherein the cleaning product has a total water absorption of at least 6.0 g per gram mass, a wet compressive modulus of less than about 3.5 N/mm, an ambient thickness of at least 4 mm, and a ratio of wet thickness to ambient thickness of greater than about 1.1.

29. A cleaning product as defined in claim 24, wherein the cleaning product has a total water absorption of at least 6.0 g per gram mass, a wet compressive modulus of less than about 3.5 N/mm, an ambient thickness of less than about 17 mm, and a ratio of wet thickness to ambient thickness of greater than about 1.1.

30. A cleaning product comprising:
a sponge-like member comprising spunbond filaments, the spunbond filaments comprising crimped, bicomponent filaments, the sponge-like member having a density of less than about 0.08 g/cc and having a basis weight of at least 100 gsm; and
a fibrous layer or an abrasive layer attached to the sponge-like member forming an exterior surface of the cleaning product.

31. A cleaning product as defined in claim 30, wherein an abrasive layer is attached to the sponge-like member for forming an exterior surface of the cleaning product.

32. A cleaning product as defined in claim 30, wherein the sponge-like member has a basis weight of greater than about 150 gsm.

33. A cleaning product as defined in claim 30, wherein the sponge-like member has a density of less than about 0.04 g/cc.

34. A cleaning product as defined in claim 30, wherein the sponge-like member has a density of less than about 0.03 g/cc.

35. A cleaning product as defined in claim 31, wherein the abrasive layer comprises a meltblown web.

36. A cleaning product as defined in claim 35, wherein about 10% or more of the mass of the meltblown web comprising meltblown fibers having a diameter of at least 40 microns.

37. A cleaning product as defined in claim 35, wherein the meltblown web has a basis weight of at least 50 gsm.

38. A cleaning product as defined in claim 30, wherein the cleaning product contains an additive comprising a soap, a detergent, a buffering agent, an antimicrobial agent, a skin wellness agent, a lotion, a medication, a polishing agent, or mixtures thereof.

39. A cleaning product as defined in claim 30, further comprising a cover layer surrounding the liquid absorbent structure, the cover layer comprising a hydroentangled web.

40. A cleaning product as defined in claim 39, wherein the fibrous layer or the abrasive layer is attached to the cover layer.

41. A cleaning product as defined in claim 30, wherein the sponge-like member has been treated chemically, electrically or mechanically in order to increase the rate of water absorption.

42. A cleaning product as defined in claim 30, further comprising absorbent material, wherein the cleaning product has a total water absorption of at least 6.0 g per gram mass and has a wet compressive modulus of less than about 3.50 N/mm.

43. A cleaning product as defined in claim 30, further comprising absorbent material, wherein the cleaning product has a total water absorption of at least 6.25 g per gram mass and has a wet compressive modulus of less than about 3.0 N/mm.

44. A cleaning product as defined in claim 30, wherein the cleaning product has an ambient thickness of at least 8 mm.

45. A cleaning product as defined in claim 30, wherein the cover layer is thermally bonded to form a seam around a perimeter of the cleaning product.

46. A cleaning product comprising:
a liquid absorbent structure containing a sponge-like member;
an abrasive layer forming an exterior surface of the cleaning product; and
wherein the cleaning product has a ratio of wet thickness to ambient thickness of greater than about 1.1.

47. A cleaning product as defined in claim 46, wherein the cleaning product has an ambient thickness of at least 10 mm, has a total water absorption of at least 6 g per gram mass, and has a wet compressive modulus of less than about 3.5 N/mm.

48. A cleaning product as defined in claim 47, wherein the cleaning product has a dry mass of less than about 11 grams.

49. A cleaning product as defined in claim 46, wherein the cleaning product has a total water absorption of greater than about 6.5 g per gram mass, has a wet compressive modulus of less than about 3.25 N/mm, and has a ratio of wet thickness to ambient thickness of greater than about 1.2.

50. A cleaning product as defined in claim 47, wherein the cleaning product has an ambient thickness of at least 12 mm.

51. A cleaning product as defined in claim 47, wherein the cleaning product has a dry mass of less than about 12 grams.

52. A cleaning product as defined in claim 47, wherein the sponge-like member comprises at least 20% by weight of the liquid absorbent structure, the sponge-like member having a density of less than about 0.05 g/cc, the sponge-like member comprising meltspun filaments.

53. A cleaning product as defined in claim 52, wherein the meltspun filaments comprise multi-component, crimped spunbond filaments.

54. A cleaning product as defined in claim 53, wherein the liquid absorbent structure further comprises a plurality of fibrous cellulosic webs.

55. A cleaning product as defined in claim 54, wherein the fibrous cellulosic webs comprise uncreped through-air dried webs.
